(19) United States
(12) Patent Application Publication
(10) Pub. No.: US 2003/0051178 A1
(43) Pub. Date: Mar. 13, 2003

(54) Mechanism for wireless modem power control

(76) Inventor: Ping Liu, South Surrey (CA)

Correspondence Address: ROBERT E. KREBS, THELEN REID & PRIEST LLP, P.O. BOX 640640, SAN JOSE, CA, 95164-0640, US

(21) Appl. No.: 09/954,612

(22) Filed: Sep. 12, 2001

(51) Int. Cl. G06F 1/26; G06F 1/28; G06F 1/30

(52) U.S. Cl. 713/300

(57) ABSTRACT

A mechanism for providing zero power control of a computer peripheral is disclosed. The mechanism comprises a switch electrically connected to a card detecting pin of the host device. The switch is operated by a retractable antenna of the card. In this respect, when the antenna is in a retracted position, the switch generates a “removed” signal to the card detecting pin. The “removed” signal simulates that the computer peripheral has been removed from the host device such that the operating software of the host device will not supply power to the card. On the other hand, when the switch detects the antenna in the extended state, the switch will generate an “inserted” signal to the card detecting pin. The “inserted” signal informs the host device operating system that a card has been inserted and that power should be applied to the card.

### BACKGROUND OF THE INVENTION

1. Field of the Invention

The present invention generally relates to power control for a computer peripheral device, and more particularly to a mechanism that simulates the insertion and removal of a PCMCIA card in order to control power to the card.

2. Status of the Prior Art

PCMCIA (Personal Computer Memory Card International Association) cards are peripheral devices that are inserted into a dedicated slot or port on computer devices. The PCMCIA card may be a wireless device such as a modem or LAN card. The PCMCIA standard includes specifications that require conformity to features for PCMCIA developers.

The physical requirements defined by the PCMCIA specification may define the number of pins in the connector (i.e., sixty-eight), the pin assignments, the size of the card, the power requirements of the card, etc. . . . The standards ensure that peripheral cards meeting the requirements will function in different devices. For instance, a card confirming to a Type I PCMCIA specification may function in a notebook computer, a PDA, a digital camera, or any other electronic device equipped with a PCMCIA slot.

The software requirements ensure that the PCMCIA card will be operative on the different devices that the card is plugged into. For example, card services provide an interface software requirement that handles communications between the PCMCIA card and the computer. The primary purpose of the card services is to inform the computer about the card including the amount of memory in the card and the type of data. On the other hand, socket services identify when the card is in the slot of the computer and provide a method for the computer to access the slot and card. Socket services check each PCMCIA slot of the computer to determine whether a card is inserted therein.

Typically, when a user inserts a PCMCIA card into the dedicated slot of an electronic device, the electronic device detects the presence of a card via the socket service with dedicated pins of the slot. If the card is detected, then the host device will provide power to the card. The socket service is enabled such that the PCMCIA card may be plug-and-play and hot swappable if needed. The PCMCIA specification is designed such that power is always applied to the card when card is in the socket. Upon insertion of the card into the PCMCIA socket, the card will be powered up. It is possible through the operating software of the electronic device to power down the PCMCIA card into a sleep mode. In the sleep mode, the card is minimally powered in order to save energy consumption. However, total cessation of power is not possible because some circuitry of the card must remain on in order to determine when to exit the sleep mode.

Often times, it is desirable to completely power down the PCMCIA card. For instance, if the card is a wireless device such as a CDPD wireless modem, the modem must be turned off during use on an aircraft in order to avoid interference. Additionally, if the card is used in a small portable device such as a PDA, then the modem should be completely powered down in order to conserve battery power when not in use. In the PCMCIA standard, the only way to ensure that the card is completely powered down (i.e., turned off) is to remove the card from the host electronic device or turn it off via a card service utility which is complicated for normal users and software (OS) dependent. Furthermore, you can only turn the card off, not turn it on. You have to remove the card from the socket and insert it back in to turn on the power.

Removing the card from the host electronic device can be inconvenient. Often times, the user of the card does not realize that the device must be removed to completely turn the device off. Once removed, the user must find a place to safely store the card. PCMCIA cards are fragile electronic devices which must be properly stored when not used in the host device in order to protect the card. Accordingly, it can be inconvenient for the user to remove the card in order to completely power down the card.

The present invention addresses the above-mentioned deficiencies in the power control of PCMCIA cards by providing a mechanism which provides zero power usage for the PCMCIA card. The present invention allows the card to remain in the host device while still completely powering down the card. Additionally, the mechanism of the present invention allows the card to be turned off and on by the user with very little effort. In fact, the mechanism of the present invention allows the user to control power to the card via a natural action.

### SUMMARY OF THE INVENTION

In accordance with the present invention, there is provided a mechanism for providing zero power control of a peripheral device such as a PCMCIA card that is insertable into a host device. The mechanism comprises a switch electrically connected to two card detecting pins of the host device. The switch is operated by a retractable antenna of the card. In this respect, when the antenna is in a retracted position, the switch generates an appropriate “removed” signal to the card detecting pins. The “removed” signal simulates removal of the PCMCIA card from the host device such that the operating software of the host device will not supply power to the card. In reality, however, the card has not been removed from the host device. On the other hand, when the antenna is in the extended state, the switch will generate an “inserted” signal to the card detecting pin. The “inserted” signal informs the host device operating system that the card is inserted and that power should be applied to the card. In this regard, the operating system of the host device functions as if the card has been inserted into the PCMCIA slot.

The switch may be a mechanical switch which senses the position of the antenna. Accordingly, when the antenna is in the retracted position (i.e., inserted within the card), the switch will be positioned to generate the “removed” signal. Conversely, when the antenna is moved to the retracted position, the switch will be positioned to generate the “inserted” signal.

The PCMCIA specification requires two pins for the card and the host device for detecting the presence of the PCMCIA card. When the pins are driven to a ground potential by the insertion of the card, then the operating system of the host system knows that a card has been inserted. In the preferred embodiment of the present invention, when the antenna is in the extended position, the switch connects the detecting pins to a ground potential thereby simulating the insertion of the card. On the other hand, when the antenna is in the retracted position, the switch removes the ground potential from the detecting pins thereby simulating removal of the card eventhough the card has not been removed. Upon sensing the simulated removal of the card, the operating system of the host device will turn off power to the card.

It will be recognized that the switch may be a mechanical micro switch or any other type of non-electrical switch/relay which connects the card detection pins to ground. The operating system is fooled into thinking that the card has either been inserted or removed depending on the position of the switch.

### BRIEF DESCRIPTION OF THE DRAWINGS

These as well as other features of the present invention will become more apparent upon reference to the drawings wherein:

FIG. 1 is a block-level diagram of a power control constructed in accordance with the present invention in the “off” state; and

FIG. 2 is a block-level diagram of the power control shown in FIG. 1 in the “on” state.

### DETAILED DESCRIPTION OF THE PREFERRED EMBODIMENT

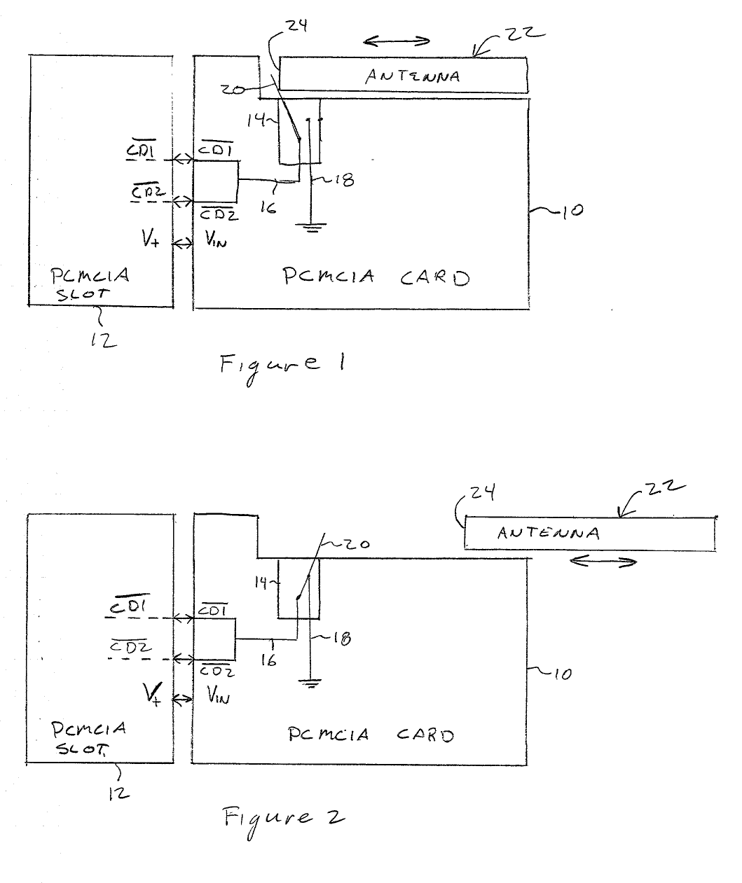

Referring now to the drawings wherein the showings are for purposes of illustrating a preferred embodiment of the present invention only, and not for purposes of limiting the same, FIG. 1 illustrates a power control constructed in accordance with the present invention for a PCMCIA card 10 that is inserted into a PCMCIA slot 12 of a host computer or electronic device. The PCMCIA slot 12 may be a port or other type of connecting device conforming to the PCMCIA specification. The slot 12 is housed within the host computer and is adaptable to receive the PCMCIA card 10. The slot 12 has two detecting pins \overline{CD1} and \overline{CD2} which detect the presence of the card 10. More particularly, when the card 10 is inserted into the slot 12, the detecting pins \overline{CD1} and \overline{CD2} are driven low (i.e., ground) by the card. The host device detects the pins being driven low and applies power to a V+pin of the slot 12. When the card 10 is removed, the detecting pins \overline{CD1} and \overline{CD2} are driven high and power is removed from the V+pin. Typically, the operating system of the host device determines the status of the detecting pins \overline{CD1} and \overline{CD2} and controls the power to V+.

The power control of the present device includes a switch 14 connected to the \overline{CD1} and \overline{CD2} pins of the card 10. The switch 14 has a first lead 16 connected to the \overline{CD1} and \overline{CD2} pins, and a second lead 18 connected to a ground potential, as seen in FIGS. 1 and 2. The first lead 16 is connected to a lever 20 of the switch 14 that is normally biased in a closed position by a spring (not shown). In the normally closed position, the lever 20 will contact the second lead 18, as seen in FIG. 2. When contacting the second lead 18, the lever 20 will electrically connect the first lead 16 with the second lead 18 thereby electrically connecting pins \overline{CD1} and \overline{CD2} to the ground potential. As such, when the switch 14 is in the normally closed position, the switch 14 will drive the detecting pins \overline{CD1} and \overline{CD2} to ground thereby simulating the insertion of the card 10 into the slot 12. However, when the switch 14 is in the open position, the detecting pins \overline{CD1} and connected only to the first lead 16 will not be driven to ground thereby simulating the removal of the card 10. Accordingly, it is possible to simulate the insertion and removal of card 10 in the slot 12 by opening and closing the switch 14.

In the preferred embodiment of the present invention, the switch 14 is positioned in a location whereat the movement of a retractable antenna 22 will open and close the switch 14. More specifically, the antenna 22 will slide within the card 10 from a retracted position (shown in FIG. 1) to an extended position (shown in FIG. 2). The antenna 22 slides within the card 10 on a track or other suitable enclosure. The antenna 22 is in the retracted position when the antenna 22 will not substantially protrude from the card 10. In the extended position, as seen in FIG. 2, a majority of the antenna 22 protrudes from the card 10. It will be recognized that in the extended position, the antenna 22 will be able to transmit and receive signals better than in the retracted position due to less interference from the host device into which the card 10 is inserted.

The extension and retraction of the antenna 22 controls the power to the card 10. More specifically, the switch 14 is placed within the card 10 such that when the antenna 22 is in the retracted position, an interior end 24 displaces the lever 20 to the open position, as seen in FIG. 1. The interior end 24 contacts the lever 20 such that an open circuit is created between the detecting pins \overline{CD1}, \overline{CD2} and ground thereby simulating the removal of the card 10. When the antenna 22 is moved to the extended position, as shown in FIG. 2, the lever 20 closes and drives the detecting pins \overline{CD1} and \overline{CD2} to the ground potential. As previously mentioned, the switch 14 closes to the normally closed position due to the biasing action of the spring (not shown). When the switch 14 is in the closed position, the detecting pins \overline{CD1} and \overline{CD2} are driven to the ground potential thereby simulating the insertion of the card 10.

By opening and closing the switch 14, it is possible to simulate the insertion and removal of the card 10 without physically removing the same. In this sense, the switch 14 generates a “removed” signal to the detecting pins \overline{CD1} and \overline{CD2} when the antenna 22 is retracted and the switch 14 is in the open position. Conversely, when the antenna 22 is in the extended position and the switch 14 is closed, an “inserted” signal is generated by the switch 14 to the detecting pins \overline{CD1} and \overline{CD2}. Accordingly, it is possible to simulate the insertion and removal of the card 10 within the slot 12 through the movement of the antenna 22. It will be recognized that moving the antenna 22 is a natural act for a user wishing to use the card 10 such that the card 10 can be easily powered on and off.

The switch 14 has been described as being a mechanical micro switch which is activated from movement of the antenna 22 via the lever 20. However, it will be recognized that the switch 14 may be a non-electrical switch/relay which connects the card detection pins \overline{CD1} and \overline{CD2} to ground. Any device which detects the position of the antenna 22 may be used to drive the detecting pins \overline{CD1} and \overline{CD2} to the proper voltage. For instance, an optical sensor may be used to determine the position of the antenna 22 within the card 10. The optical sensor will open and close the switch 14, as necessary. On the other hand, a magnetic device may be used to determine the position of the antenna 22.

Additional modifications and improvements of the present invention may also be apparent to those of ordinary skill in the art such as adapting the power control for different card standards. For instance, even though the present invention has been described for PCMCIA cards, it will be recognized that the power control for other formats of cards may utilize the present invention. Thus, the particular combination of parts described and illustrated herein is intended to represent only a certain embodiment of the present invention, and is not intended to serve as a limitation of alternative devices within the spirit and scope of the invention.

1. A power control for a peripheral device insertable into a host device, the power control comprising:
a switch configured to generate a signal that simulates the insertion and removal of the peripheral device within the host device such that power from the host device will be supplied to the peripheral device when simulating the device is inserted into the host device and power will be removed from the peripheral device when simulating the peripheral device is removed from the host device;
wherein the peripheral device is not physically inserted or removed from the host device.

2. The power control of claim 1 wherein the switch is configured to generate an inserted signal simulating insertion of the peripheral device and a removed signal simulating removal of the peripheral device.

3. The power control of claim 2 wherein the switch is configured to generate the inserted signal upon extension of an antenna of the peripheral device and configured to generate the removed signal upon retraction of the antenna.

4. The power control of claim 3 wherein the switch is electrically connected to detecting pins of the host device, the detecting pins determining whether the peripheral device is inserted or removed from the host device.

5. The power control of claim 4 wherein the switch is operative to generate an open circuit as the removed signal and a low voltage level as the inserted signal.

6. The power control of claim 5 wherein the low voltage level is a ground potential.

7. The power control of claim 5 wherein the switch includes a lever which detects the position of the antenna in order to generate the inserted and removed signals.

8. The power control of claim 7 wherein the peripheral device is a PCMCIA card.

9. A method of controlling power to a peripheral device insertable into a host device, the method comprising the steps of:
a) simulating the insertion of the peripheral device with a switch by generating an inserted signal such that the host device supplies power to the peripheral device; and
b) simulating the removal of the peripheral device with the switch by generating a removed signal such that the host device removes power from the peripheral device.

10. The method of claim 9 wherein the switch is in electrical communication with detecting pins of the host device and step (a) further comprises generating the inserted signal on the detecting pin and step (b) further comprises generating the removed signal on the detecting pins.

11. The method of claim 10 wherein step (a) comprises generating the inserted signal upon extension of an antenna of the peripheral device and step (b) comprises generating the detecting signal upon retraction of the antenna of the peripheral device.

12. The method of claim 11 wherein step (a) comprises generating the inserted signal by forming a low voltage signal on the detecting pin of the host device and step (b) comprises generating the removed signal by forming an open circuit on the detecting pin of the host device.

13. The method of claim 12 wherein the low voltage signal is a ground potential.

14. The method of claim 12 wherein step (a) comprises detecting the extension of the antenna with the switch and step (b) comprises detecting the retraction of the antenna with the switch.

15. The method of claim 14 wherein step (a) comprises detecting the extension of the antenna with a lever of the switch and step (b) comprises detecting the retraction of the antenna with the switch.

16. A power control for a peripheral device insertable within a host device, the power control comprising:
means for simulating the insertion of the peripheral device into host device; and
means for simulating the removal of the peripheral device from host device.

17. The power control of claim 16 wherein the means for simulating insertion and the means for simulating removal is a switch.

18. The power control of claim 17 wherein the switch is operative to generate a signal simulating the removal and insertion of the peripheral device.

19. The power control of claim 18 wherein the switch is in electrical communication with a detecting pin of the host device and the switch is operative to generate the signal on the detecting pin.

20. The power control of claim 19 wherein the switch is operative to generate an inserted signal simulating the insertion of the peripheral device and a removed signal simulating the removal of the peripheral device.

21. The power control of claim 20 wherein the switch is operative to generate an o pen circuit as the removed signal and a low voltage level as the inserted signal.

22. The power control of claim 21 wherein the low voltage level is a ground potential.

23. The power control of claim 22 wherein the switch detects the position of the antenna in order to generate the inserted and removed signals.

24. The power control of claim 23 wherein the switch has a lever which detects the position of the antenna.
